(19) United States
(12) Patent Application Publication
(10) Pub. No.: US 2015/0050135 A1
(43) Pub. Date: Feb. 19, 2015

(54) STATOR BLADE DIAPHRAGM RING, STEAM TURBINE AND METHOD

(71) Applicant: Nuovo Pignone SRL, Florence (IT)

(72) Inventors: Marco Grilli, Pisa (IT); Enrico Giusti, Pistoia (IT); Enzo Imparato, Sesto Fiorentino (IT)

(21) Appl. No.: 14/390,910

(22) PCT Filed: Apr. 2, 2013
(86) PCT No.: PCT/EP2013/056960

§ 371 Date: Oct. 6, 2014

(30) Foreign Application Priority Data
Apr. 6, 2012 (IT) CO2012A000014

(51) Int. Cl. F01D 9/04; B23P 15/00

(52) U.S. Cl. CPC F01D 9/041; F01D 9/042; B23P 15/00
USPC 415/193; 415/209.1; 29/889.22

(57) ABSTRACT

A stator blade diaphragm ring includes a plurality of stator blades each having a root and a radial pin receiver. The diaphragm ring further includes a first ring having a plurality of slots, wherein each slot is engaged by the root of one of the plurality of stator blades and a second ring having a plurality of radial through passageways, wherein each radial through passageway is aligned with the radial pin receiver of one of the plurality of stator blades. The diaphragm also includes a plurality of pins, wherein each pin extends from one of the radial through passageways into the radial pin receiver of one of the plurality of stator blades.

### BACKGROUND

Embodiments of the present invention relate generally to turbo-machines, in particular steam turbines, and, more specifically, to a stator blade diaphragm and a method of making a stator blade diaphragm.

A steam turbine is a turbo machine which converts thermal and pressure energy of steam into rotary motion which may be used to perform work. Steam turbines may be used, for example, to drive electrical generators or compressors.

To enhance steam turbine efficiency, steam is often expanded through a number of stages. Each stage may include a stator blade diaphragm and a bearing mounted rotor assembly including at least one impeller.

In modern steam turbines, the manufacture of stator blade diaphragms represents a significant cost, particularly in multi-stage steam turbines having three or more stages, each of which may include one or more separate stator blade diaphragms.

In one such manufacturing process, a number of individual stator blades and spacers are machined. Then, one end of the blades and the spacers are alternately placed around the circumference of a stator ring. The free end of each blade includes a post extending from one end. A shroud strip having holes is then hammered onto the loose free ends of the blades until the posts extend out of the back side of the strip. This process is time consuming, labor intensive, and potentially damaging to all of the stator diaphragm parts. For example, during hammering, one or more stator blades may be bent or otherwise deformed. Even if the stator blades are not deformed, there remains a likelihood that the blades and/or other parts of the diaphragm will be angled and/or spaced improperly due to the potentially imprecise hammer blows.

Accordingly, what is needed is a stator blade diaphragm which is less costly, more likely to conform to design specifications, and requires less time to manufacture.

### BRIEF SUMMARY OF THE INVENTION

According to an exemplary embodiment, a stator blade diaphragm ring includes a plurality of stator blades each having a root and a radial pin receiver. The diaphragm ring further includes a first ring having a plurality of slots, wherein each slot is engaged by the root of one of the plurality of stator blades and a second ring having a plurality of radial through passageways, wherein each radial through passageway is aligned with the radial pin receiver of one of the plurality of stator blades. The diaphragm also includes a plurality of pins, wherein each pin extends from one of the radial through passageways into the radial pin receiver of one of the plurality of stator blades.

According to another exemplary embodiment, a turbo machine includes a rotor assembly including at least one impeller, a bearing connected to, and for rotatably supporting, the rotor assembly, and a stator assembly including a segmented stator diaphragm ring. Each segment of the stator diaphragm ring comprises a stator blade having first and second ends each with at least one pin receiver, a first ring segment having at least one radial through passageway, each of the at least one radial through passageway aligned with a corresponding one of the at least one pin receiver in the first end of the stator blade and a second ring segment having at least one radial through passageway, each of the at least one radial through passageway aligned with a corresponding one of the at least one pin receiver in the second end of the stator blade. The turbo machine further includes a plurality of pins extending from the radial through passageways of the first and second ring segments into the stator blade pin receivers.

According to another exemplary embodiment, a method of making a stator diaphragm comprising a plurality of stator blades, a first ring and a second ring can include the steps of inserting a root of each of the plurality of stator blades into a corresponding one of the plurality of root receivers in a first ring, positioning the second ring around the plurality of stator blades such that a plurality of radial through passageways in the second ring align with a plurality of pin receivers in the plurality of stator blades, inserting a plurality of pins through the plurality of radial through passageways such that each of the plurality of pins extends from a corresponding one of the plurality of passageways into a corresponding one of the plurality of pin receivers, and, vacuum brazing the plurality of pins to at least one of the plurality of radial through passageways and at least one of the plurality of pin receivers.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows a perspective view of a stator blade diaphragm ring according to an exemplary embodiment.

FIG. 2 shows a stator blade of the exemplary embodiment of FIG. 1.

FIG. 3 shows a cross-sectional view of the exemplary embodiment shown in FIG. 1.

FIG. 4 shows another stator blade diaphragm ring according to an exemplary embodiment.

FIG. 5 shows a stator blade attached to an inner ring with a pin according an exemplary embodiment.

FIG. 6 shows a stator blade attached to an inner ring made of two parts according to an exemplary embodiment.

FIG. 7 shows a stator blade having integral pins according to an exemplary embodiment.

FIG. 8 shows a stator blade attached with multiple pins according to an exemplary embodiment.

FIG. 9 is a flowchart illustrating a method of making a diaphragm ring according to an exemplary embodiment.

FIG. 10 depicts a steam turbine.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a turbo-machine that has a stator and a rotor. However, the embodiments to be discussed next are not limited to these exemplary systems, but may be applied to other systems.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

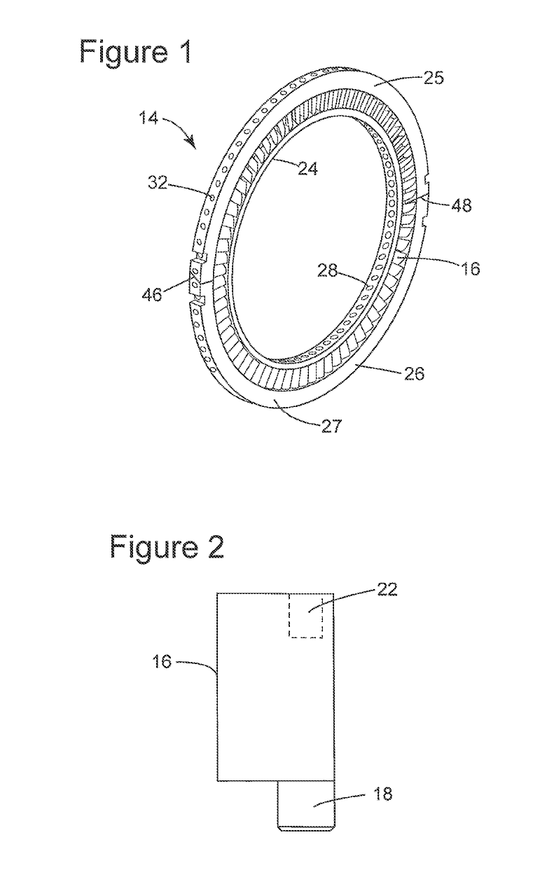

FIGS. 1 to 3 show a stator blade diaphragm 14 according to an exemplary embodiment of the present invention. Diaphragm 14 may be used in a stator assembly, for example, a steam turbine 500 to be discussed later. As shown in FIGS. 1 to 3, the stator blade diaphragm 14 includes a plurality of stator blades 16 each of which includes a cylindrical root 18 (FIG. 2) and a cylindrical radial pin receiver 22 (FIG. 2).

Diaphragm 14 further includes an inner ring 24 having a plurality of cylindrical radial slots 28 and an outer ring 26 having a plurality of cylindrical radial passageways 32. In the embodiment of FIGS. 1 to 3, the radial slots 28 extend through the inner ring 24 thereby forming holes. Note that each slot 28 is configured such that each root 18 may be inserted directly into a slot 28 without, for example, having to be slid through a channel and/or separated from an adjacent blade with a spacer, as previously discussed. The engagement of each root 18 with each slot 28 may also be configured to provide a slight interference or friction fit such that each blade 16 remains in place during further assembly steps.

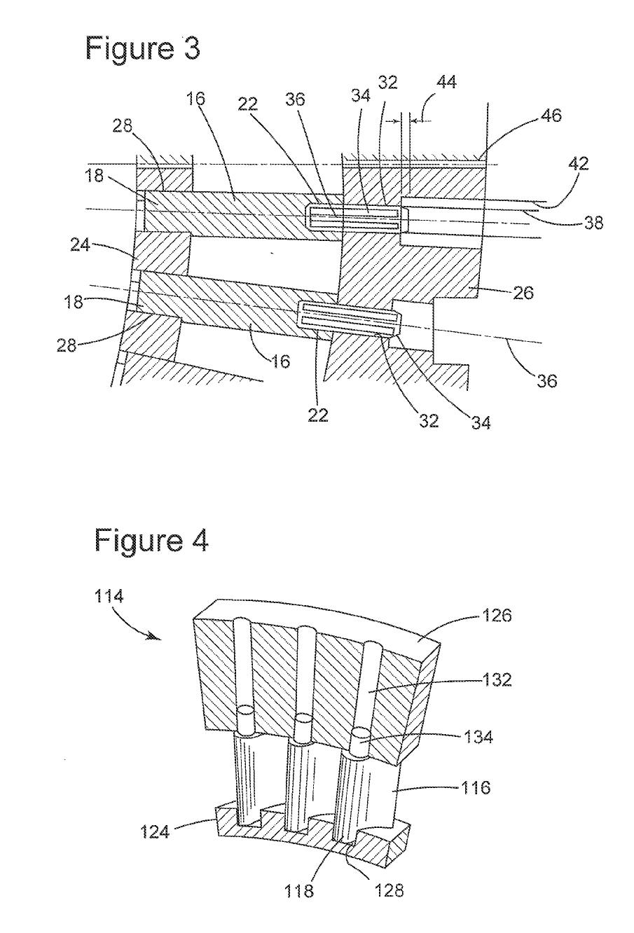

As shown in FIG. 3, a cylindrical pin 34 extends from each radial through passageway 32 into each radial pin receiver 22 thereby securing each blade 16 between the inner ring 24 and outer ring 26. During assembly, the outer ring 26 is positioned such that the stator blades 16 are disposed between the inner ring 24 and the outer ring 26. The slots 28 on the inner ring 24 may be configured such that when the outer ring 26 is placed over the blades 16, each of the radial through passageways 32 is automatically indexed or aligned to respective stator blade radial pin receivers 22, thereby rendering the assembly process easier. Each pin 34 is then inserted into one of the radial through passageways 32 and advanced until seated, partially, in a respective radial pin receiver 22. Note that the open radial slot 28, radial pin receiver 22, pin 34 and radial through passageway 32 lie on a radial axis 36 of diaphragm 14.

Each radial pin receiver 22 may be configured to provide an interference or friction fit with each pin 34 such that each blade 16 remains in place during further assembly steps. Alternatively, pin 34, radial through passageway 32 and pin receiver 22 may be configured such that upon seating of each pin 34 within each pin receiver 22, each blade 16 may be sufficiently secure between the inner ring 24 and the outer ring 26 to render the assembly of diaphragm ring 14 complete.

One or more radial through passageways 32 in outer ring 26 may include a first portion 38 having a first cross-sectional area and a second portion 42 having a second cross-sectional area larger than the first cross-sectional area. For example, first portion 38 may have a cylindrical cross-sectional area corresponding to pin 34 and second cross-sectional area 42 may have a second cross-sectional area configured to provide enhanced access, for example, to allow a tool to easily reach within radial passageway 32. Further, and as shown in FIG. 3, a portion 44 of pin 34 may extend into the second portion 42 of the radial passageway 32 when the pin 34 is seated within the radial pin receiver 22.

It is to be noted that, in an embodiment of FIG. 3, the stator blades 16 do not extend into the outer ring 26, so that the outer ring 26 may be placed over the blades 16 without even if the outer ring 26 is in a single piece or divided into a small number of pieces; this is valid also for the embodiment of FIG. 4. In particular, the outer end surface of the stator blades 16 mate with the inner surface of the outer ring 26.

In the embodiment of FIGS. 1 to 3, each pin 34 may be vacuum brazed to a corresponding one of the radial passageways 32 and to the radial pin receiver 22 in which each pin 34 is seated. Further, each root 18 may be vacuum brazed to its corresponding slot 28. The vacuum brazing process further secures each stator blade 16 to inner ring 24, outer ring 26, and each pin 34 and may be performed in a single uniform heating and cooling cycle of diaphragm 14. The vacuum brazing equipment used to perform the vacuum brazing of diaphragm 14 can be standard vacuum brazing equipment as, for example, disclosed in U.S. Pat. Nos. 4,874,918 and 4,401,254, the disclosures of which are incorporated here by reference.

For the brazing process, in an embodiment, a brazing paste is used; the brazing paste is, in an embodiment, a nickel-based brazing paste, or, in an embodiment, a nickel-phosphorus brazing paste.

In the embodiment of FIG. 3, some brazing paste is inserted into each slot 28 before inserting each root 18; some brazing paste is inserted into each through passageways 32 after inserting each pin 34. The gaps between blades 16, the inner ring 24, the outer ring 26 and the pins 34 are dimensioned so that, during the brazing process, the brazing paste melts and by capillarity rises along the slots 28 till the upper surface of the inner ring 24 and moves along the pins 34; in this way, a prefect sealing is obtained between the blades 16 and the rings 24 and 26.

As further shown in FIGS. 1 and 3, the inner ring 24 and outer ring 26 may be cut between the brazing connections at a first location 46 and a second location 48 along the circumference of diaphragm 14. The resulting segmented diaphragm may be easier to install to a stator assembly such as within steam turbine 500. Moreover, since the cuts provide relief from the constraints associated with a continuous ring including vacuum brazed connections, the segmented diaphragm ring 14 may be better able to accommodate sudden and/or localized heat related expansion and contraction which may occur during startup or shut down of a steam turbine in which diaphragm 14 is installed. In the embodiment of FIGS. 1 and 3, the first location 46 and the second location 48 of the cuts in diaphragm 14 are selected to provide first and second stator diaphragm segments 25 and 27 of equal length, i.e., stator diaphragm 14 half ring segments.

FIG. 4 shows an alternative embodiment of diaphragm ring 114 in which each of the stator blade roots 118 and each of the inner ring slots 128 are provided with an oval cross-section to prevent relative axial rotation between each stator blade 116 and inner ring 124. Alternatively, one or more of the roots 118 and one or more respective slots 128 may be provided with other corresponding non-circular cross-sectional shapes. Similarly, one or more of the pins 134 and one or more respective pin receivers (not shown in FIG. 4) or radial passageways 132 may be provided with corresponding non-circular cross-sectional shapes to further prevent axial rotation of blades 116.

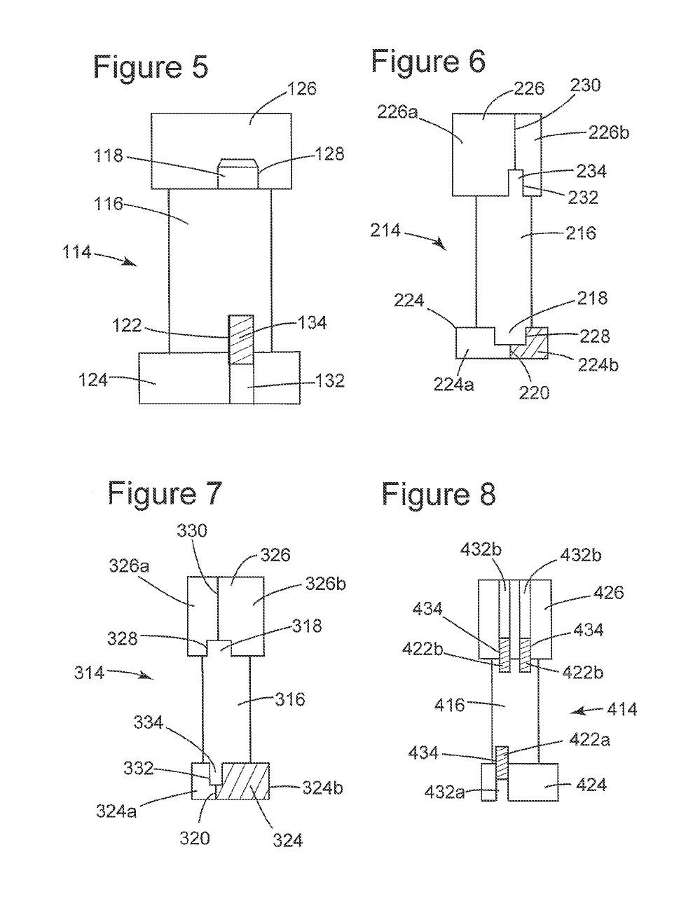

In the embodiment shown in FIGS. 1 to 3, blade 16 is configured such that the root 18 engages the inner ring 24 while the pin receiver aligns with a radial passageway in the outer ring 26. However, one of ordinary skill in the art will appreciate that other configurations are possible, for example, and as shown in FIG. 5, a blade 116 may include a root 118 which engages a slot 128 in the outer ring 126 and a pin receiver 122 which receives a pin 134 extending from a radial passageway 132 in the inner ring 124. In operation, the non-circular profile of root 118 and slot 128 in outer ring 126 may assist in preventing axial rotation of blade 116.

In another alternative embodiment shown in FIG. 6, blade 216 includes an integral pin 234 extending from a first end and a root 218 extending from a second end thereof. After integral pin 234 is received in a radial passageway 232 of outer ring 226, root 218 may be secured to inner ring 224. Specifically, the inner ring 224 of the embodiment shown in FIG. 6 includes a first ring portion 224a and second ring portion 224b engaged to each other along a circumferential interface 220. This feature allows each root 218 to be engaged by each corresponding slot 228 simply by bringing the ring portions 224a and 224b into engagement with each other. As shown in FIG. 6 the circumferential interface 220 may intersect, and more specifically, bisect each of the plurality of slots 228.

Each blade 216 may then be secured to the inner ring portions 224a and 224b, for example, by a vacuum braze between each root 218 and inner portions 224a and 224b and/or a vacuum braze between inner ring portions 224a and 224b along the interface 220. Blade 216 including integral pin 234 may be similarly secured to outer ring 226. As further shown in FIG. 6, and as an alternative or in addition to inner ring 224, outer ring 226 may also be provided with a first ring portion 226a and second ring portion 226b engaged to each other along a circumferential interface 230. Further, the circumferential interface 230 may intersect each of the plurality of radial passageways 232.

FIG. 7 shows another alternative embodiment. Blade 316 is similar to blade 216, however, root 318 extends into a slot 328 in the outer ring 326 and integral pin 334 extends into a radial passageway 332 formed by inner ring 324. Inner ring 324 may include ring portions 324a and 324b engaged to each other along circumferential interface 320. Alternatively, or in addition to inner ring 324, outer ring 326 may be provided with a first ring portion 326a and a second ring portion 326b engaged to each other along circumferential interface 330.

In another exemplary embodiment shown in FIG. 8, a first end of each blade 416 is provided with a pin receiver 422a engaged by a pin 434 extending from a radial passageway 432a in the inner ring 424. A second end of each blade is provided with at least two pin receivers 422b engaged by pins 434 extending from radial passageways 432b in outer ring portion 426. In the embodiment of FIG. 8, the pins 434 extending into pin receivers 422b may assist in preventing axial rotation of blade 416. Note that pins 434, pin receivers 422a and 422b, as well as radial passageways 432a and 432b may each be provided with a corresponding non-circular cross section to further assist in preventing movement between blade 416, inner ring 424 and outer ring 426. Further, note that the pins 434 may be secured to inner ring 424, outer ring 426, and/or blades 416 by vacuum brazing. It should thus be apparent that in one aspect of the present invention, either or both of the inner and outer rings may be provided with a combination of slots and/or radial passageways and further that the blades may each be provided with identical or different combinations of corresponding roots, pin receivers, and/or integral pins.

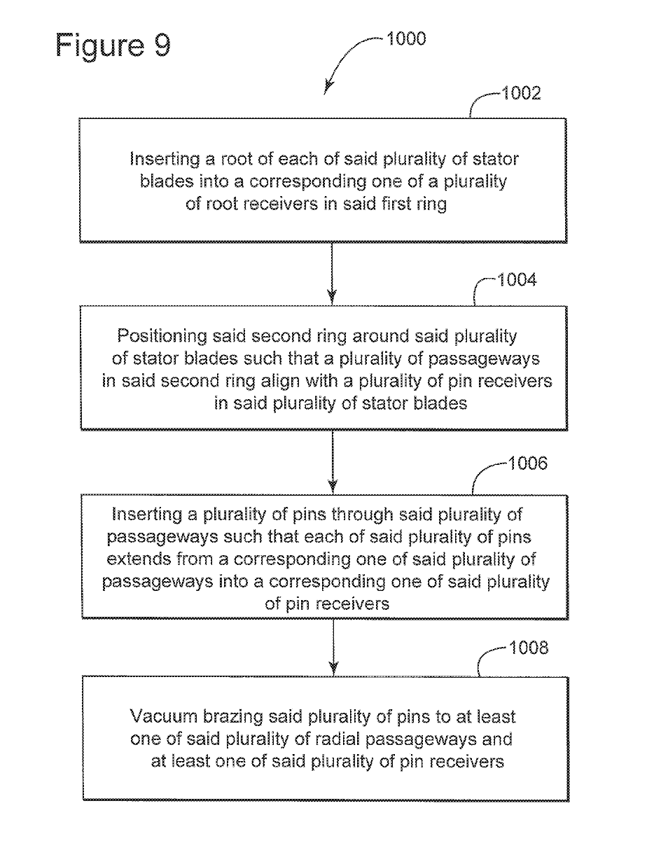

According to an exemplary embodiment shown in FIG. 9, a method (1000) of making a stator diaphragm according to the present invention can include the steps of inserting (1002) a root of each of the plurality of stator blades into a corresponding one of the plurality of root receivers in a first ring; positioning (1004) the second ring around the plurality of stator blades such that a plurality of passageways in the second ring align with a plurality of pin receivers in the plurality of stator blades; inserting (1006) a plurality of pins through the plurality of passageways such that each of the plurality of pins extends from a corresponding one of the plurality of passageways into a corresponding one of the plurality of pin receivers; and, vacuum brazing (1008) the plurality of pins to at least one of the plurality of radial passageways and at least one of the plurality of pin receivers.

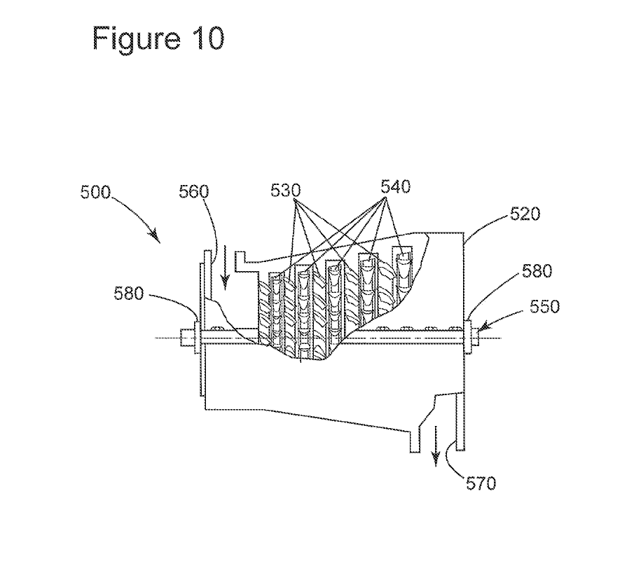

The novel stator blade diaphragms discussed above may be implemented, for example, into a steam turbine. In this regard, FIG. 10 schematically illustrates a multistage steam-turbine 500. Therein, the steam turbine 500 includes a housing (stator) 520 within which a number of stator blade diaphragms 530 are disposed along with a rotor shaft 550 provided with a plurality of impeller rotors 540. The shaft 550 is supported radially and axially through bearings 580.

During operation, the steam turbine takes a steam input from an inlet 560 through various stages of expansion, to an outlet 570 leading to a condenser. At each turbine stage, steam is directed by a stator diaphragm 530 onto an impeller rotor 540 thereby converting the temperature and pressure energy of the steam into rotating energy available for work at the rotor shaft 550.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A stator blade diaphragm ring, comprising:
a plurality of stator blades each comprising a root and a radial pin receiver;
a first ring comprising a plurality of slots, wherein each slot is engaged by the root of one of the plurality of stator blades;
a second ring comprising having a plurality of radial through passageways, wherein each radial through passageway is aligned with the radial pin receiver of one of the plurality of stator blades; and
a plurality of pins, wherein each of the pins extends from one of the radial through passageways into a radial pin receiver of one of the plurality of stator blades.

2. The stator blade diaphragm ring of claim 1, wherein the radial through passageways have cross-sections sized so that to allow through passage of the pins and mating with the pins when the pins extend into the radial pin receivers.

3. The stator blade diaphragm ring of claim 1, wherein the stator blades do not extend into the second ring.

4. The stator blade diaphragm ring of claim 1, wherein the outer end surface of the stator blades mate with the inner surface of the second ring.

5. The stator blade diaphragm ring of claim 1, wherein at least one of the plurality of pins is brazed to one of the plurality of second ring passageways.

6. The stator blade diaphragm ring of claim 5, wherein at least one of the plurality of pins is brazed the radial pin receiver of one of the plurality of stator blades.

7. The stator blade diaphragm ring of claim 6, wherein the root of at least one of the plurality of stator blades is brazed to one of the slots.

8. The stator blade diaphragm ring of claim 7, wherein the first ring and the second ring are cut radially between the brazings thereby forming a segmented stator blade diaphragm ring.

9. The stator blade diaphragm ring of claim 1, wherein the root of at least one of the plurality of stator blades and the at least one slot have corresponding non-circular cross-sectional shapes thereby preventing relative axial rotation between the at least one stator blade and the first ring.

10. The stator blade diaphragm ring of claim 1, wherein the pin receiver of at least one the stator blade, at least one of the plurality of pins, and at least one of the radial passageways have corresponding non-circular cross-sectional shapes thereby preventing relative axial rotation between Bathe at least one the stator blade and the second ring.

11. A turbo-machine comprising:
a rotor assembly comprising at least one impeller;
a bearing connected to, and for rotatably supporting, the rotor assembly; and
a stator assembly comprising a segmented stator diaphragm ring, wherein the segmented stator diaphragm ring comprises:
a plurality of stator blades each comprising a root and a radial pin receiver;
a first ring comprising a plurality of slots, wherein each slot is engaged by the root of one of the plurality of stator blades;
a second ring comprising a plurality of radial through passageways, wherein each radial through passageway is aligned with the radial pin receiver of one of the plurality of stator blades; and
a plurality of pins, wherein each of the pins extends from one of the radial through passageways into a radial pin receiver of one of the plurality of stator blades.

12. A method of making a stator diaphragm ring comprising a plurality of stator blades, a first ring and a second ring, the method comprising:
inserting a root of each of the plurality of stator blades into a corresponding one of a plurality of root receivers in the first ring;
positioning the second ring around the plurality of stator blades such that a plurality of through passageways in the second ring align with a plurality of pin receivers in the plurality of stator blades;
inserting a plurality of pins through the plurality of through passageways such that each of the plurality of pins extends from a corresponding one of the plurality of passageways into a corresponding one of the plurality of pin receivers; and
vacuum brazing the plurality of pins to at least one of the plurality of radial passageways and at least one of the plurality of pin receivers.

13. The method of making a stator diaphragm ring of claim 12, wherein some brazing paste is inserted into the root receivers of the first ring before inserting the roots of the stator blades.

14. The method of making a stator diaphragm ring of claim 12, wherein some brazing paste is inserted into the through passageways of the second ring after inserting the pins.

15. The method of making a stator diaphragm ring of claim 12, wherein the brazing paste is a nickel-based brazing paste, preferably a nickel-phosphorus brazing paste.

16. The stator blade diaphragm ring of claim 2, wherein the stator blades do not extend into the second ring.

17. The stator blade diaphragm ring of claim 2, wherein the outer end surface of the stator blades mate with the inner surface of the second ring.

18. The stator blade diaphragm ring of claim 2, wherein at least one of the plurality of pins is brazed to the radial pin receiver of one of the plurality of stator blades.

19. The stator blade diaphragm ring of claim 2, wherein the root of at least one of the plurality of stator blades is brazed to one of the slots.

20. The stator blade diaphragm ring of claim 2, wherein the first ring and the second ring are cut radially between the brazings thereby forming a segmented stator blade diaphragm ring.
